(19) United States
(12) Patent Application Publication
(10) Pub. No.: US 2017/0090705 A1
(43) Pub. Date: Mar. 30, 2017

(54) CONVERSATION AND VERSION CONTROL FOR OBJECTS IN COMMUNICATIONS

(71) Applicant: MICROSOFT TECHNOLOGY LICENSING, LLC, Redmond, WA (US)

(72) Inventors: Kip Fern, Redmond, WA (US); Joey Masterson, Bellevue, WA (US); Alex Darrow, Redmond, WA (US); Hayley Steplyk, Cambridge, MA (US)

(21) Appl. No.: 14/870,022

(22) Filed: Sep. 30, 2015

(51) Int. Cl. G06F 3/0484; G06F 17/21; H04L 12/58; G06F 3/0481; H04L 29/08; G06F 17/22; G06F 17/24

(52) U.S. Cl. CPC G06F 3/0484; G06F 17/2288; G06F 17/2211; G06F 17/212; G06F 17/241; G06F 3/0481; H04L 67/1097; H04L 51/08

(57) ABSTRACT

Conversation and version control is provided for objects in communications. An application, such as a communication application, identifies attachments within communications in response to an input to display attachment summaries associated with the attachments. The attachment summaries are displayed in a summary view. In response to an action on one of the attachment summaries, attachment management elements and an attachment associated with the attachment summary is displayed in an attachment view. The attachment management elements include operations to present information associated with the attachment, the communications associated with the attachment, versions of the attachment, and participants associated with the attachment.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications facilitate communications. Attachment management in a communication application complicate participant workflows.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to conversation and version control for objects in communications. In some examples, a communication application, such as an email processing application, may detect an input to display attachment summaries associated with attachments of communications. In response to the input, attachments within the communications may be identified. Attachment summaries associated with the identified attachments may be displayed in a summary view. Next, an action on one of the attachment summaries may be detected. In response to the action, attachment management elements and an attachment associated with the attachment summary may be displayed in an attachment view. The attachment management elements may include operations to present information associated with the attachment, the communications associated with the attachment, versions of the attachment, and participants associated with the attachment.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of providing conversation and version control for objects in communications, according to embodiments;

FIG. 2 is a display diagram illustrating an example of a communication application that provides elements to interact with an attachment associated with a communication, according to embodiments;

FIG. 3 is a display diagram illustrating an example of a communication application that provides elements to interact with communications associated with an attachment, according to embodiments;

FIG. 4 is a display diagram illustrating an example of a communication application that provides elements to interact with versions of an attachment, according to embodiments;

FIG. 5 is a display diagram illustrating an example of a communication application that provides elements to interact with participants associated with an attachment, according to embodiments;

FIG. 6 is a simplified networked environment, where a system according to embodiments may be implemented;

FIG. 7 is a block diagram of an example computing device, which may be used to provide conversation and version control for objects in communications; and

FIG. 8 is a logic flow diagram illustrating a process for providing conversation and version control for objects in communications, according to embodiments.

### DETAILED DESCRIPTION

As briefly described above, conversation and version control for objects in communications may be provided by a communication application. The communication application may include an email processing application, a messaging application, and/or a conferencing application, among others. In an example scenario, the communication application may detect an input to display attachment summaries associated with attachments of communications. A communication may include an email, a message, and/or a video/audio conference, among others. A communication may also be referred to as a conversation. An attachment may include a document, an image, a video file, and/or an audio file, among others.

Attachments within the communications (accessible by the communication application) may be identified. Attachment summaries associated with the attachments may be displayed in a summary view of the communication application. The attachment summaries may include a name of an associated attachment, a time received of the associated attachment, and/or a number of the communications associated with the attachment, among others.

Next, an action on one of the attachment summaries may be detected. In response, attachment management elements and an attachment associated with the attachment summary may be displayed in an attachment view of the communication application. The attachment management elements may include operations to present information associated with the attachment, the communications associated with the attachment, versions of the attachment, and participants associated with the attachment.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide conversation and version control in communications. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

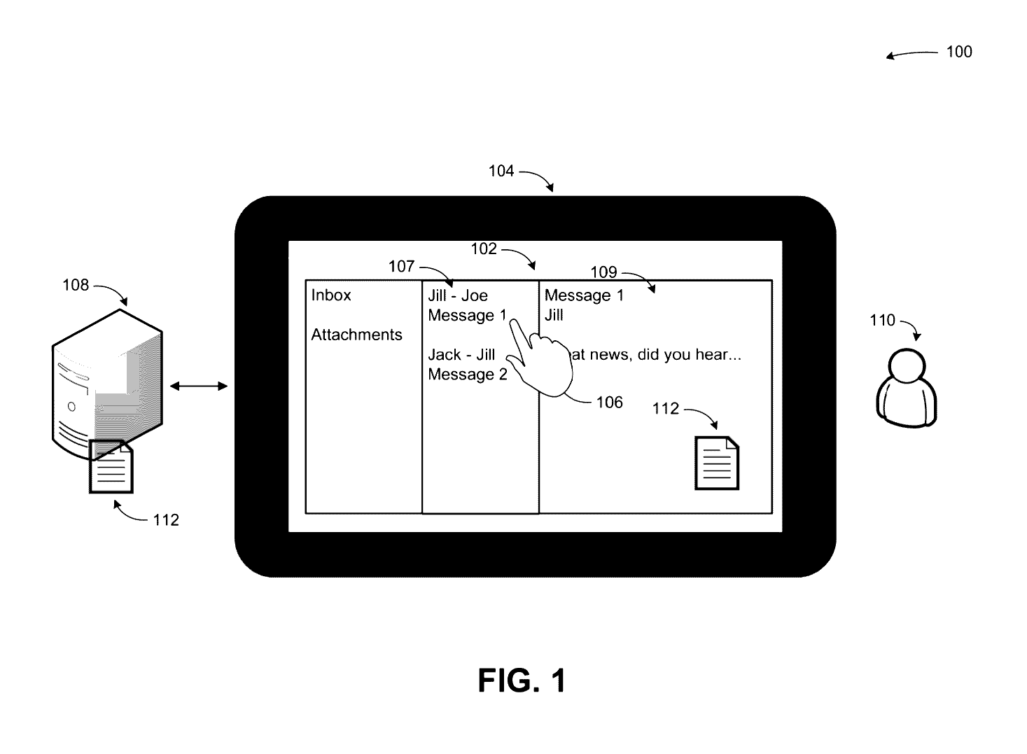

FIG. 1 is a conceptual diagram illustrating an example of providing conversation and version control for objects in communications, according to embodiments.

In a diagram 100, a computing device 104 may execute a communication application 102. Examples of the communication application may include an email processing application, a messaging application, and/or a conferencing application, among others. The computing device 104 may include a tablet device, a laptop computer, a desktop computer, and a smart phone, among others. The computing device 104 may include a special purpose computing device configured to provide communications management through a display component configured to display communications, a communication component configured to transmit communications, and/or a storage component configured to store communications, among other components.

The computing device 104 may display the communication application 102 to a participant 110. The participant 110 may be allowed to interact with the communication application 102 through an input device or touch enabled display component of the computing device 104. The computing device 104 may also include a display device such as the touch enabled display component, and a monitor, among others to provide the communication application 102 to the participant 110.

The communication application 102 may present communication summaries 107 associated with communications between the participant 110 and other participants. A communication may include an email, a message, a video conference, and/or an audio conference, among others. A process to manage attachments may be initiated when the participant 110 may apply an action 106 on one of the communications summaries 107. The action 106 may include a selection, and/or an activation, among others on an element presented by the communication application 102. In response to the action 106, the communication application 102 may display a communication 109 in a communication view.

The communication 10′) may include an attachment 112. The attachment 112 may include a document, an image, a video file, and/or an audio file, among others. The attachment 112 may be stored locally within the computing device 104. Alternatively, the attachment 112 may be retrieved from a server 108.

The server 108 may include a content server and/or a communication server, among others. The server 108 may also host and manage communications and attachments associated with communications. An example of the server 108 may include an email server that provides communications to be presented by the communication application 102. Additionally, the computing device 104 may communicate with the server 108 through a network. The network may provide wired or wireless communications between nodes such as the computing device 104, or the server 108, among others.

The participant 110 may interact with the communication application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 104, the communication application 102, embodiments are not limited to these components or system configurations and can be implemented with other system configuration employing fewer or additional components.

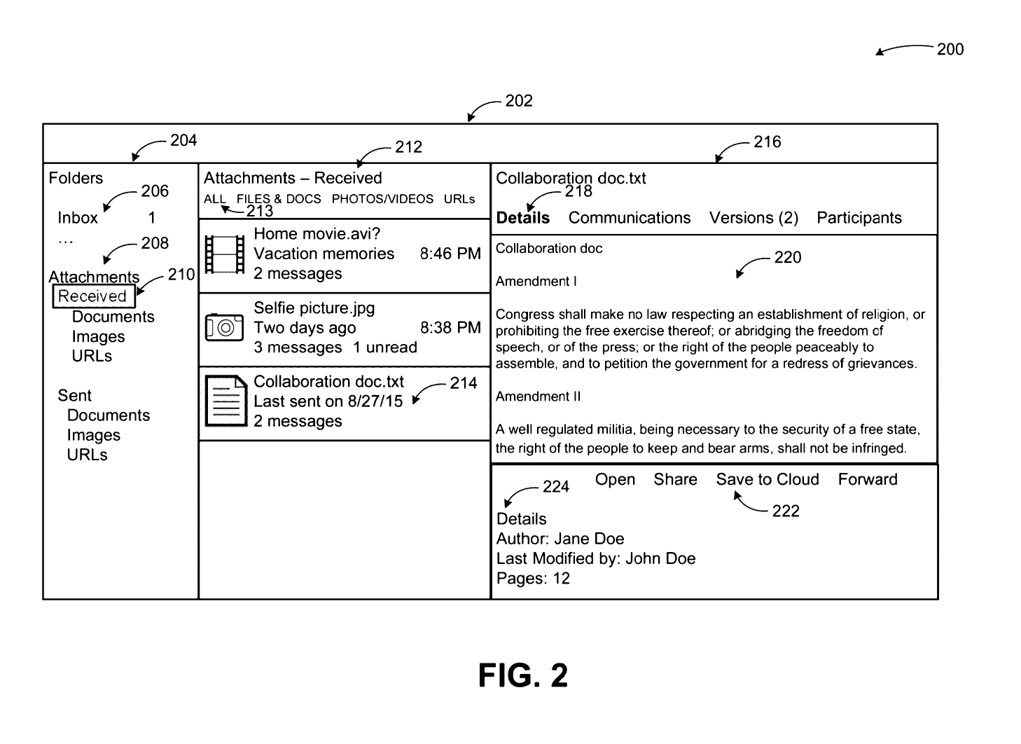

FIG. 2 is a display diagram illustrating an example of providing conversation and version control for objects in communications, according to embodiments.

In a diagram 200, a communication application 202 may display elements to interact with attachments within communications. An example of the communication application 202 may include an email processing application. An example of a communication may include an email. An example of an attachment may include a document collaborated on by multiple participants.

The communication application 202 may display a navigation menu 204 to present navigation elements to interact with communications and attachments. A navigation element 206 may include operations to provide summaries of communications in a communication summary view. Furthermore, the navigation elements may include attachment navigation elements 208. The attachment navigation elements 208 may include operations to interact with a grouping of attachments. The attachments may be grouped based on a type associated with the attachments such as a document, an image, an audio, a video, and/or a uniform resource locator (URL), among others.

In response to an input that activates an attachment navigation element 210, the attachment navigation element 210 may be highlighted and communications (accessible to the communication application 202) may be searched to identify attachments. Attachment summaries associated with located (or identified) attachments may be presented in a summary view 212. In addition, grouping elements 213 may be presented to display and sort attachment summaries to groupings based on a type of the associated attachments.

In response to an action on an attachment summary 214, the attachment summary 214 may be highlighted with a highlighting scheme such as a background shading, a foreground shading, and/or an animation, among others. Furthermore, an attachment 220 associated with the attachment summary 214 may be displayed in an attachment view 216.

Attachment management elements 218 may also be presented in the attachment view 216. The attachment management elements 218 may include operations to present information associated with the attachment, the communications associated with the attachment, versions of the attachment, and/or participants associated with the attachment, among others.

The attachment 220 may be provided with elements to edit the contents. Notes and tags may be attached to the attachment 220. Edits or changes to the attachment 220 may be saved manually or automatically.

The attachment view 216 may also display storage elements 222 that include operations associated with storage or transmission of the attachment 220. In response to an action on an open file element, an application associated with the attachment 220 may be prompted to open and display the attachment 220. For example, a document processing application may be prompted to open and display the attachment 220 when the attachment 220 is detected as a document.

In response to detecting an action on a share element, privileges associated with the attachment 220 may be granted to a participant to access the attachment 220. The privileges may be specified with the share element or with additional elements associated with the share element. The participant may also be notified of a share granted to access the attachment 220.

In response to detecting an action on a save to cloud element, the attachment 220 may be saved to a location in a cloud storage. The location may be specified with the save to cloud element or with additional elements associated with the save to cloud element. In addition, in response to detecting an action on the forward element, the attachment 220 may be transmitted to a participant. The participant may be specified with the forward element or identified in a communication associated with the attachment.

Description information 224 associated with the attachment 220 may also be presented within the attachment view 216. The description information 224 may include a creator of the attachment 220, a last modifier of the attachment 220, categories associated with the attachment 220, tags attached to the attachment 220, and/or a number of pages of the attachment 220, among others.

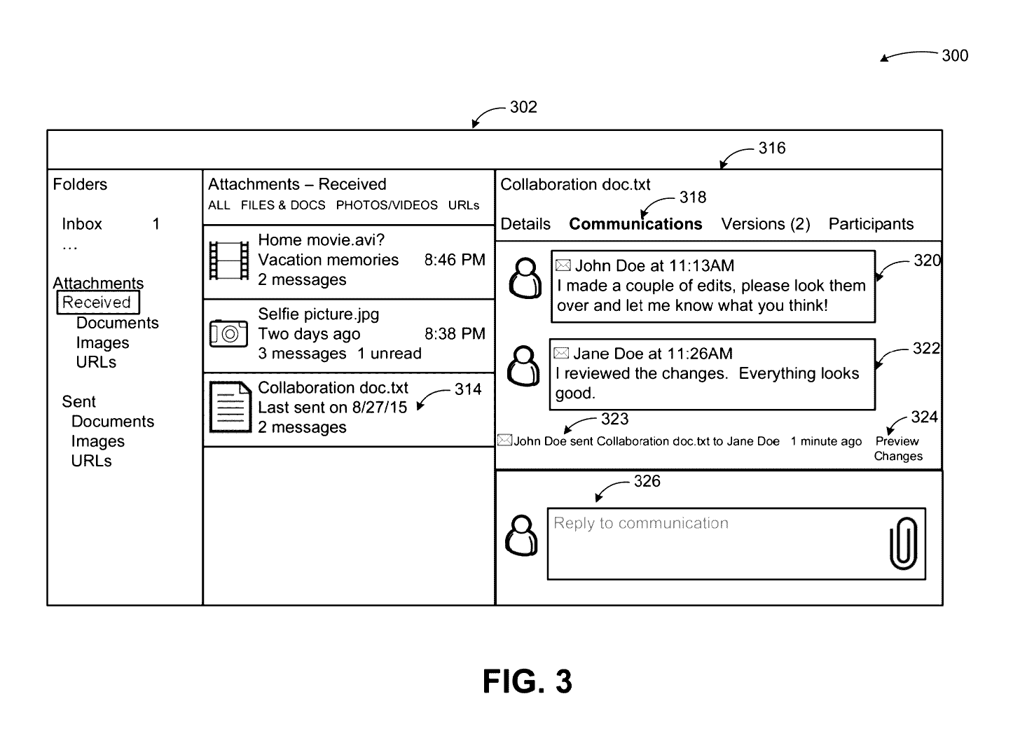

FIG. 3 is a display diagram illustrating an example of a communication application that provides elements to interact with communications associated with an attachment, according to embodiments.

In a diagram 300, a communication application 302 may present summaries of communications associated with an attachment. An example of the communication application 302 may include an email processing application. An example of a communication may include an email.

In an example scenario, the communication application 302 may detect an action on a communication management element 318. In response to the action, the communication application 302 may identify communications associated with an attachment (that is associated with an attachment summary 314). The communication management element 318 may also be highlighted to indicate that communication summaries (320 and 322) are presented in the attachment view 316.

The communications associated with the attachment may be identified by accessing source information of the attachment. The source information may point to the communications associated with the attachment. Alternatively, communications accessible by the communication application 302 may be searched to locate communications associated with the attachment.

Next, the communications summaries (320 and 322) associated with the attachment may be displayed in the attachment view 316. The communication application 302 may display a graphical representation of a sender, a name of the sender, a time received, a time sent, and a subject of an associated communication for each of the communication summaries (320 and 322) within the attachment view 316.

A description of a transmission 323 of an attachment sent to a participant may also be provided within the attachment view 316. The description may include a preview changes element 324. The preview of change element 324 may include operations to present changes between the attachment and a previously transmitted version of the attachment. For example, in response to an activation of the preview changes element 324, the attachment may be displayed on the attachment view 316 with markings to indicate changes between a current version and one or more previously transmitted versions. Alternatively, an application associated with the attachment may be prompted to display the attachment with markings to indicate changes between a current version and one or more previously transmitted versions.

Response elements 326 may also be provided within the attachment view 316. In response to detecting an entry of a response communication addressing one of the communications (320 and 322), the response communication may be recorded. In response to instructions to transmit, the response communication may be transmitted to a participant as instructed in the response communication. A communication summary of the response communication may be added to the attachment view 316 along with the communication summaries (320 and 322).

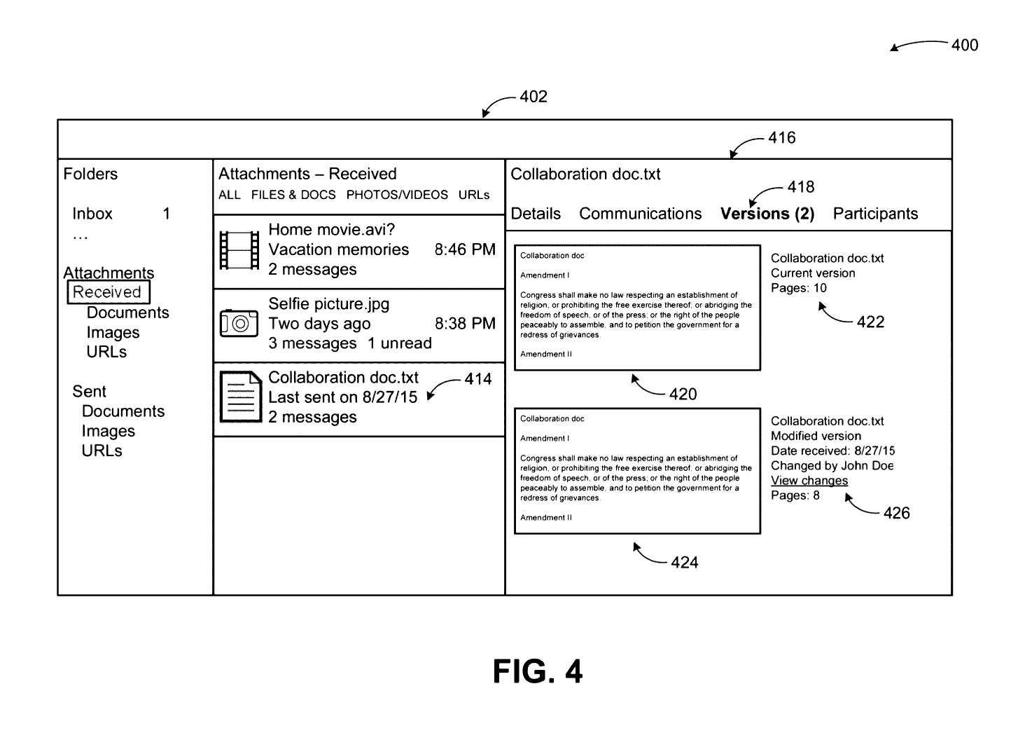

FIG. 4 is a display diagram illustrating an example of a communication application that provides elements to interact with versions of an attachment, according to embodiments.

In a diagram 400, a communication application 402 may display version summaries (420 and 424) of an attachment (that is associated with an attachment summary 414) in response to an action on a version management element 418. An example of the communication application 402 may include an email processing application. An example of a communication may include an email.

The version management element 418 may be highlighted to indicate version summaries (420 and 424) displayed in the attachment view 416. The version management element 418 may also include a number to indicate a number of versions of the attachment.

In response to detecting an action on the version management element 418, versions of the attachment may be identified. The versions may be retrieved from an attachment storage provider. The versions may also be located in previous communications associated with the attachment. Furthermore, the versions may be retrieved from a local or remote source that maintains versions of the attachment.

The version summaries (420 and 424) may be displayed in the attachment view 416. The version summaries (420 and 424) may include a graphical representation of an associated version of the attachment. The graphical representation may include a first page of the associated version of the attachment. The graphical representation may also be activated to execute operations to prompt an application (associated with the attachment) to present the associated version of the attachment.

The version summary 420 may include a version description 422. The version description 422 may include a name of the attachment, a label for the associated version, a time/date received associated with the version, a change time/date associated with the version, a number of pages within the version, and/or a view changes element, among others. A view changes element 426 may also be presented to display changes between a current version of the attachment and a previous version of the attachment associated with the view changes element 426.

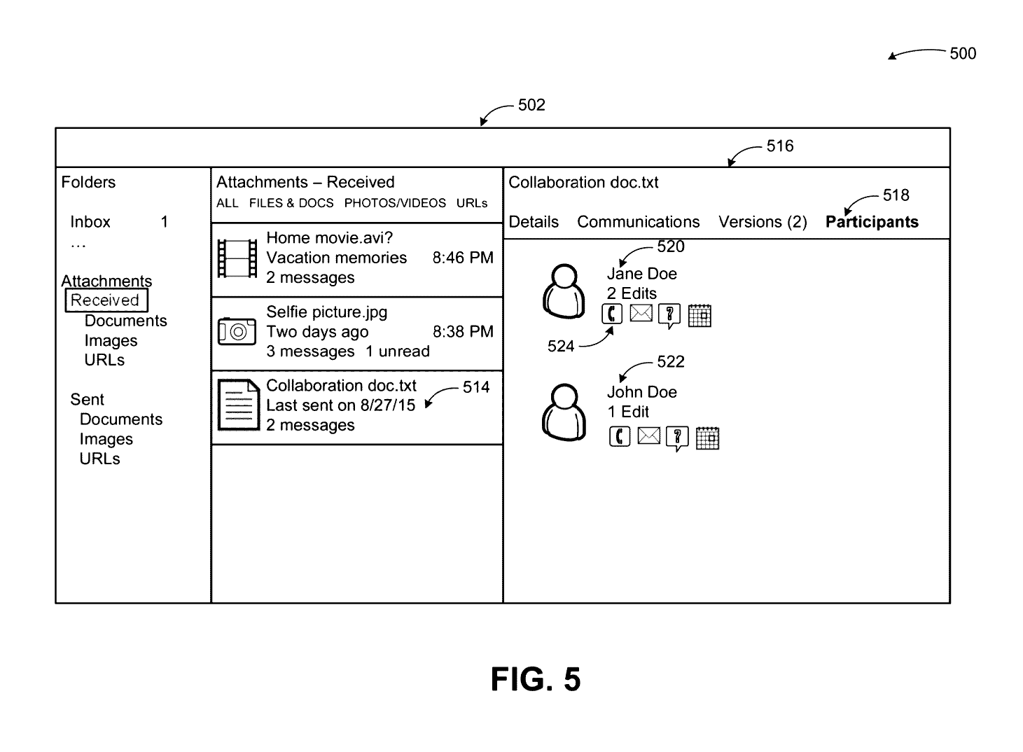

FIG. 5 is a display diagram illustrating an example of a communication application that provides elements to interact with participants associated with an attachment, according to embodiments.

In a diagram 500, a communication application 502 may display participants associated with an attachment (associated with an attachment summary 514). The participants may collaborate on the attachment through communications transmitted between the participants.

In response to detecting an action on a participants management element 518, participants associated with the attachment may be identified by searching and identifying the participants in communications associated with the attachment. Next, the participant summaries (520 and 522) of the participants may be displayed in an attachment view 516. The communication application 502 may also display a graphical representation of an associated participant, a name of the associated participant, a number of edits applied to the attachment by the associated participant, and elements 524 to communicate with the associated participant for each of the participants within the attachment view 516. The elements 524 may include operations to contact the associated participant by voice, audio, video, text based, and/or calendar based, among other modalities of communications.

As discussed above, the application may be employed to perform operations associated with providing conversation and version control for objects in communications. An increased user efficiency with the communication application 102 may occur as a result of attachment management elements with operations to highlight relationships between attachments, communications, and participants. Additionally, presenting an attachment, associated communications, versions of the attachment, and associated participants in an attachment view of the communication application 102 may reduce processor load, increase processing speed, conserve memory, and reduce network bandwidth usage.

Embodiments, as described herein, address a need that arises from a lack of efficiency between the participant 110 interacting with the communication application 102 of the computing device 104. The actions/operations described herein are not a mere use of a computer, but address results that are a direct consequence of software used as a service offered to large numbers of users and applications.

The example scenarios and schemas in FIG. 1 through 5 are shown with specific components, data types, and configurations. Embodiments are not limited to systems according to these example configurations. Providing conversation and version control in communications may be implemented in configurations employing fewer or additional components in applications and user interfaces. Furthermore, the example schema and components shown in FIG. 1 through 5 and their subcomponents may be implemented in a similar manner with other values using the principles described herein.

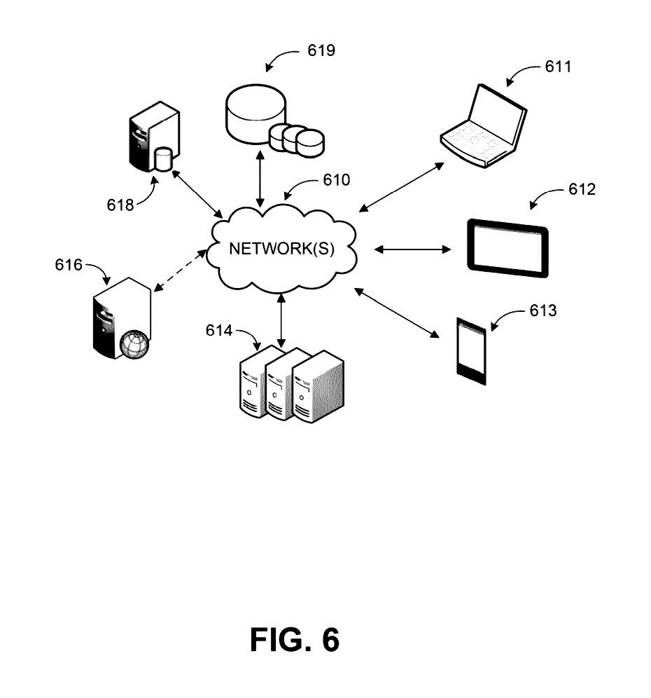

FIG. 6 is an example networked environment, where embodiments may be implemented. A communication application configured to provide conversation and version control for objects in communications may be implemented via software executed over one or more servers 614 such as a hosted service. The platform may communicate with client applications on individual computing devices such as a smart phone 613, a mobile computer 612, or desktop computer 611 (‘client devices’) through network(s) 610.

Client applications executed on any of the client devices 611-613 may facilitate communications via application(s) executed by servers 614, or on individual server 616. A communication application may identify attachments within communications in response to an input to display attachment summaries. The attachment summaries associated with the identified attachments may be displayed in a summary view. In response to detecting an action on one of the attachment summaries, an attachment associated with the attachment summary and attachment management elements may be displayed in an attachment view. The communication application may store data associated with the attachment in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to provide conversation and version control for objects in communications. Furthermore, the networked environments discussed in FIG. 6 are for illustration purposes only. Embodiments are not limited to the example applications, modules, or processes.

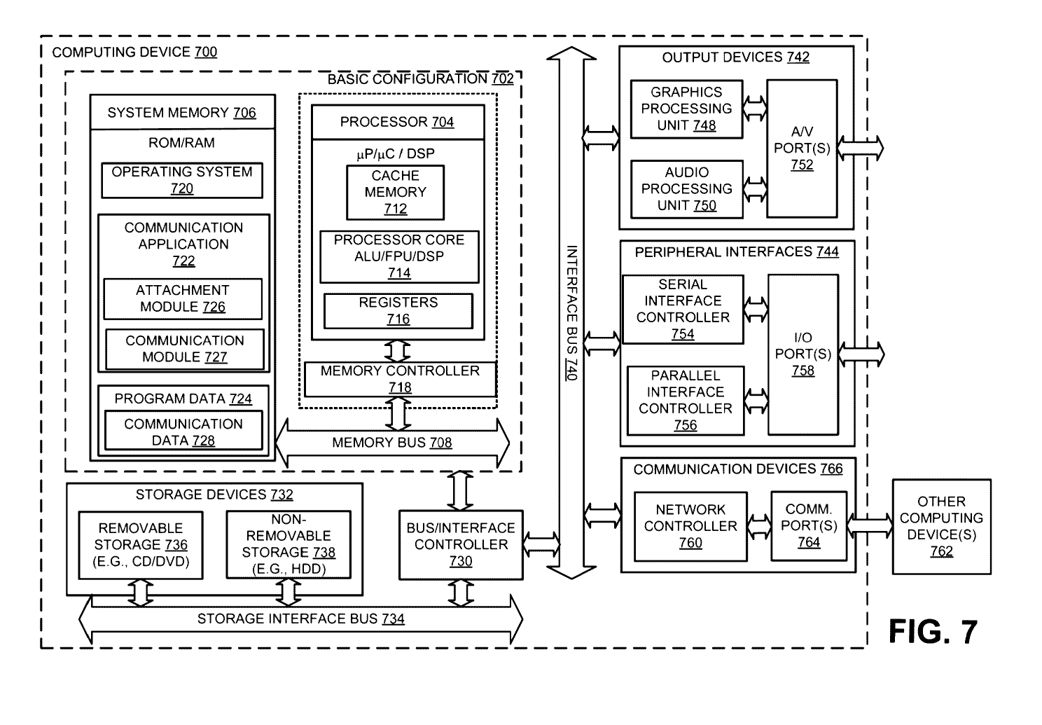

FIG. 7 is a block diagram of an example computing device, which may be used to provide conversation and version control for objects in communications.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a communication application 722, and a program data 724. The communication application 722 may include components such as an attachment module 726 and a communication module 727. The attachment module 726 and the communication module 727 may execute the processes associated with the communication application 722. The communication module 727 may identify attachments within communications in response to an input to display attachment summaries. The attachment module 726 may display the attachment summaries associated with the identified attachments in a summary view. In response to detecting an action on one of the attachment summaries, an attachment associated with the attachment summary and attachment management elements may be displayed in an attachment view by the attachment module 726.

Components of the communication application 722 (such as a user interface) may also be displayed on a display device associated with the computing device 700. An example of the display device may include a hardware screen that may be communicatively coupled to the computing device 700. The display device may include a touch based device that detects gestures such as a touch action. The display device may also provide feedback in response to detected gestures (or any other form of input) by transforming a user interface of the communication application 722, displayed by the touch based device. The program data 724 may also include, among other data, communication data 728, or the like, as described herein. The communication data 728 may include an attachment, among others.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer, which includes any of the above functions. The computing device 700 may also be implemented as a personal computer including both laptop computer and non-laptop computer configurations.

Example embodiments may also include methods to provide conversation and version control for objects in communications. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

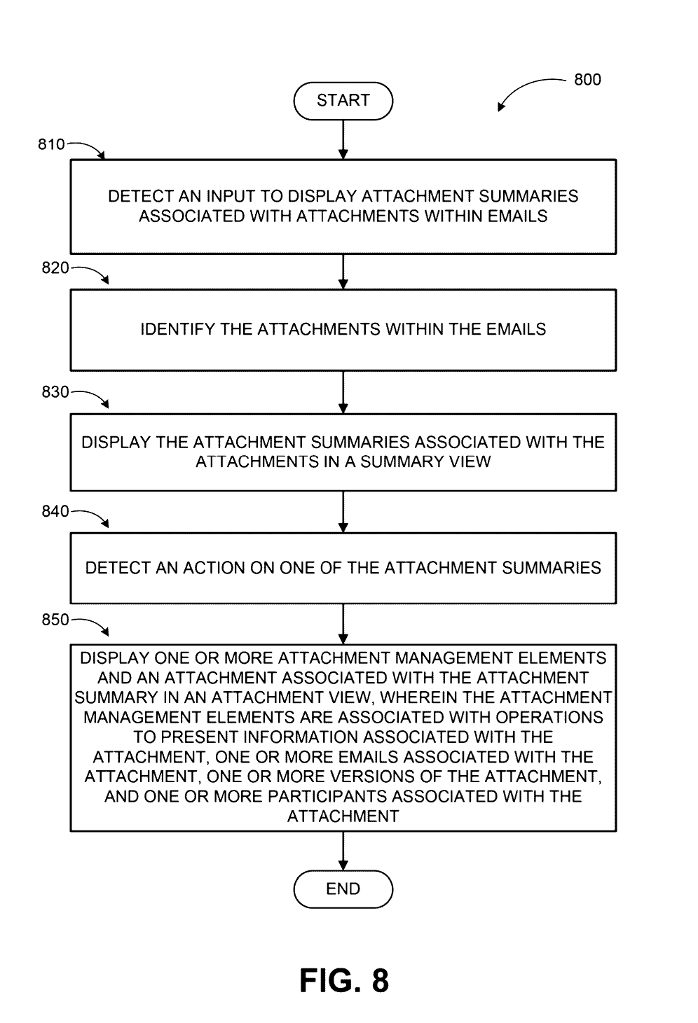

FIG. 8 is a logic flow diagram illustrating a process for providing conversation and version control objects in communications, according to embodiments. Process 800 may be implemented on a computing device, such as the computing device 700 or another system.

Process 800 begins with operation 810, where a communication application, such as an email processing application, may detect an input to display attachment summaries associated with attachments of communications. An example of a communication may include an email, among others. At operation 820, the attachments may be identified within the communications. The communications (accessible by the communication application) may be searched to identify the attachments stored within the communications.

At operation 830, the attachment summaries associated with the attachments may be displayed in a summary view. The attachment summaries may be displayed in a sortable list format. The attachments summaries may be sorted based on attributes of the associated attachments. At operation 840, an action on one of the attachment summaries may be detected. In response, attachment management elements and an attachment associated with the attachment summary may be displayed in an attachment view at operation 850. The attachment management elements may include operations to present information associated with the attachment, the communications associated with the attachment, versions of the attachment, and participants associated with the attachment.

The operations included in process 800 are for illustration purposes. Providing conversation and version controls for objects in communications may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some examples, a computing device for providing conversation and version control for objects in communications may be described. The computing device includes a display device, a memory configured to store instructions associated with an email processing application, and one or more processors coupled to the memory and the display device. The one or more processors execute the email processing application in conjunction with the instructions stored in the memory. The email application includes a communication module and an attachment module. The communication module is configured to detect an input to display attachment summaries associated with attachments within emails. The attachment module is configured to identify the attachments within the emails, display the attachment summaries associated with the attachments in a summary view, detect an action on one of the attachment summaries, and display one or more attachment management elements and an attachment associated with the attachment summary in an attachment view, where the attachment management elements are associated with operations to present information associated with the attachment, one or more emails associated with the attachment, one or more versions of the attachment, and one or more participants associated with the attachment.

According to other examples, the attachment module is further configured to present description information associated with the attachment in the attachment view, where the description information includes one or more of: a creator, a last modifier, one or more associated categories, one or more tags, and a number of pages. The attachment module is further configured to display one or more storage elements in the attachment view, where the one or more storage elements include an open file element, a share element, a save to cloud element, and a forward element. The attachment module is further configured to in response to detecting an action on the open file element, prompt a document application to open and display the attachment and in response to detecting an action on the share element, grant privileges to a participant to access the attachment, and notify the participant of a share granted to access the attachment. The attachment module is further configured to in response to detecting an action on the save to cloud element, save the attachment to a location in a cloud storage and in response to detecting an action on the forward element, transmit the attachment to a participant, where the participant is identified in an email associated with the attachment.

According to further examples, the attachment module is further configured to detect an action an email management element from the attachment management elements, identify one or more emails associated with the attachment, and display email summaries associated with the one or more emails within the attachment view. The attachment module is further configured to display one or more of: a graphical representation of a sender, a name of the sender, a time received, a time sent, and a subject of an associated email for each of the one or more email summaries within the attachment view. The attachment module is further configured to provide, within the attachment view, a description of a transmission of the attachment to a participant, where the description includes a preview changes element to present changes between the attachment and a previously transmitted version of the attachment, in response to detecting an action on the preview changes element, display changes between the attachment and the previously transmitted version. The attachment module is further configured to provide response elements within the attachment view to edit a response email o an email associated with the attachment, detect an action to transmit the response email, transmit the response email, and display another email summary associated with the response email along with the email summaries within the attachment view.

According to some examples a method executed on a computing device for providing conversation and version control for objects in communications. The method includes detecting an input to display attachment summaries associated with attachments of communications, identifying the attachments within the communications, displaying the attachment summaries associated with the attachments in a summary view, detecting an action on an attachment, where the attachment summary is highlighted in response to the action, and displaying attachment management elements and an attachment associated with the attachment summary in an attachment view, where the attachment management elements include operations to present information associated with the attachment, one or more communications associated with the attachment, one or more versions of the attachment, and one or more participants associated with the attachment.

According to other examples, the method further includes detecting an action on a version management element from the attachment management elements, identifying one more versions of the attachment, and displaying version summaries associated with the one or more versions within the attachment view. The method further includes presenting one or more of: a graphical representation of an associated version of the attachment and a version description for each of the one or more version summaries. The method further includes providing a view changes element with the one or more version summaries, where the view changes element includes operations to present changes between a current version of the attachment and a previous version of the attachment. The method further includes detecting an action on a participants management element from the attachment management elements, identifying one or more participants associated with the attachment, displaying participant summaries associated with the one or more participants within the attachment view, presenting one or more of: a graphical representation of an associated participant, a name of the associated participant, a number of edits applied to the attachment by the associated participant, and one or more elements to communicate with the associated participant for each of the one or more participants within the attachment view.

According to some examples a computer-readable memory device with instructions stored thereon for providing conversation and version control for objects in communications may be described. The instructions may include actions that are similar to the method described above.

According to some examples, a means for providing conversation and version control for objects in communications may be described. The means for providing conversation and version control for objects in communications may include a means for detecting an input to display attachment summaries associated with attachments within emails, a means for identifying the attachments within the emails, a means for displaying the attachment summaries associated with the attachments in a summary view, a means for detecting an action on one of the attachment summaries, and a means for displaying one or more attachment management elements and an attachment associated with the attachment summary in an attachment view, where the attachment management elements are associated with operations to present information associated with the attachment, one or more emails associated with the attachment, one or more versions of the attachment, and one or more participants associated with the attachment.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device for providing conversation and version control for objects in communications, the computing device comprising:
a display device;
a memory configured to store instructions associated with an email processing application;
one or more processors coupled to the memory and the display device, the one or more processors executing the email processing application in conjunction with the instructions stored in the memory, wherein the email application includes:
a communication module configured to:
detect an input to display attachment summaries associated with attachments within emails; and
an attachment module configured to:
identify the attachments within the emails;
display the attachment summaries associated with the attachments in a summary view;
detect an action on one of the attachment summaries; and
display one or more attachment management elements and an attachment associated with the attachment summary in an attachment view, wherein the attachment management elements are associated with operations to present information associated with the attachment, one or more emails associated with the attachment, one or more versions of the attachment, and one or more participants associated with the attachment.

2. The computing device of claim 1, wherein the attachment module is further configured to:
present description information associated with the attachment in the attachment view, wherein the description information includes one or more of: a creator, a last modifier, one or more associated categories, one or more tags, and a number of pages.

3. The computing device of claim 1, wherein the attachment module is further configured to:
display one or more storage elements in the attachment view, wherein the one or more storage elements include an open file element, a share element, a save to cloud element, and a forward element.

4. The computing device of claim 3, wherein the attachment module is further configured to:
in response to detecting an action on the open file element, prompt a document application to open and display the attachment; and
in response to detecting an action on the share element,
grant privileges to a participant to access the attachment, and
notify the participant of a share granted to access the attachment.

5. The computing device of claim 3, wherein the attachment module is further configured to:
in response to detecting an action on the save to cloud element, save the attachment to a location in a cloud storage; and
in response to detecting an action on the forward element, transmit the attachment to a participant, wherein the participant is identified in an email associated with the attachment.

6. The computing device of claim 1, wherein the attachment module is further configured to:
detect an action an email management element from the attachment management elements;
identify one or more emails associated with the attachment; and
display email summaries associated with the one or more emails within the attachment view.

7. The computing device of claim 6, wherein the attachment module is further configured to:
display one or more of: a graphical representation of a sender, a name of the sender, a time received, a time sent, and a subject of an associated email for each of the one or more email summaries within the attachment view.

8. The computing device of claim 6, wherein the attachment module is further configured to:
provide, within the attachment view, a description of a transmission of the attachment to a participant, wherein the description includes a preview changes element to present changes between the attachment and a previously transmitted version of the attachment.

9. The computing device of claim 8, wherein the attachment module is further configured to:
in response to detecting an action on the preview changes element, display changes between the attachment and the previously transmitted version.

10. The computing device of claim 6, wherein the attachment module is further configured to:
provide response elements within the attachment view to edit a response email o an email associated with the attachment.

11. The computing device of claim 10, wherein the attachment module is further configured to:
detect an action to transmit the response email;
transmit the response email; and
display another email summary associated with the response email along with the email summaries within the attachment view.

12. A method executed on a computing device for providing conversation and version control for objects in communications, the method comprising:
detecting an input to display attachment summaries associated with attachments of communications;
identifying the attachments within the communications;
displaying the attachment summaries associated with the attachments in a summary view;
detecting an action on an attachment, wherein the attachment summary is highlighted in response to the action; and
displaying attachment management elements and an attachment associated with the attachment summary in an attachment view, wherein the attachment management elements include operations to present information associated with the attachment, one or more communications associated with the attachment, one or more versions of the attachment, and one or more participants associated with the attachment.

13. The method of claim 12, further comprising:
detecting an action on a version management element from the attachment management elements;
identifying one more versions of the attachment; and
displaying version summaries associated with the one or more versions within the attachment view.

14. The method of claim 13, further comprising:
presenting one or more of: a graphical representation of an associated version of the attachment and a version description for each of the one or more version summaries.

15. The method of claim 13, further comprising:
providing a view changes element with the one or more version summaries, wherein the view changes element includes operations to present changes between a current version of the attachment and a previous version of the attachment.

16. The method of claim 12, further comprising:
detecting an action on a participants management element from the attachment management elements;
identifying one or more participants associated with the attachment; and
displaying participant summaries associated with the one or more participants within the attachment view.

17. The method of claim 16, further comprising:
presenting one or more of: a graphical representation of an associated participant, a name of the associated participant, a number of edits applied to the attachment by the associated participant, and one or more elements to communicate with the associated participant for each of the one or more participants within the attachment view.

18. A computer-readable memory device with instructions stored thereon for providing conversation and version control for objects in communications, the instructions comprising:
detecting an input to display attachment summaries associated with attachments of communications;
identifying the attachments within the communications;
displaying the attachment summaries associated with the attachments in a summary view;
detecting an action on an attachment summary, wherein the attachment summary is highlighted in response to the action; and
displaying attachment management elements and an attachment associated with the attachment summary in an attachment view, wherein the attachment management elements include operations to present information associated with the attachment, one or more communications associated with the attachment, one or more versions of the attachment, and one or more participants associated with the attachment.

19. The computer-readable memory device of claim 18, wherein the instructions further comprise:
detecting an action on a communication management element from the attachment management elements;
identifying one or more communications associated with the attachment;
displaying communication summaries associated with the one or more communications within the attachment view; and
displaying one or more of: a graphical representation of a sender, a name of the sender, a time received, a time sent, and a subject of an associated communication for each of the one or more communication summaries.

20. The computer-readable memory device of claim 18, wherein the instructions further comprise:
detecting an action on a version management element from the attachment management elements;
identifying one or more versions of the attachment;
displaying version summaries of the one or more versions within the attachment view; and
presenting one or more of: a graphical representation of an associated version of the attachment and a version description for each of the version summaries.
